(19) United States
(12) Patent Application Publication
(10) Pub. No.: US 2015/0113869 A1
(43) Pub. Date: Apr. 30, 2015

(54) Modular Plant Growing System with Support and Protection Features

(71) Applicant: Gregory H. Brown, Eagle, ID (US)

(72) Inventor: Gregory H. Brown, Eagle, ID (US)

(21) Appl. No.: 14/063,251

(22) Filed: Oct. 25, 2013

(51) Int. Cl. A01G 9/12

(52) U.S. Cl. CPC A01G 9/12
USPC 47/29.1; 47/20.1

(57) ABSTRACT

A plant growing system protects plants during spring, for early and/or fast growth, and supports the plants later in the growing season. Frames hold panels that protect the plants by enclosing, shielding, and/or shading the interior growing space, and upon removal of the panels, the frames may support the larger plants and their fruit/vegetables. Multiple cooperating frames pivotally connect to form modular units of various sizes and shapes, and a latching/locking feature may stabilize the unit by preventing accidental disconnection of the frames. The frames may include feature(s) that allow, and stabilize, stacking of multiple units for accommodating taller plants. The panels held by the frames may be translucent/transparent, opaque, or a combination of the two, for customizing the interior environment inside each modular unit to the plant(s), the time of year, and/or the location and climate.

### BACKGROUND OF THE INVENTION

1. Field of the Invention

The invention relates generally to growing systems for garden plants, such as tomatoes, wherein the plant may be sheltered and/or supported. Certain embodiments relate to a system for encouraging growth of a plant or plants by providing protection from cold, wind, and/or excess sun. Certain embodiments relate to a modular system wherein a support and shelter system is expandable and/or changeable in shape to accommodate various plants, growing sites, and/or grower preferences.

2. Related Art

Many green houses have been designed for sprouting seeds and encouraging growth in advance of the time that the plants can be transplanted outdoors. Cold frames have been designed for similar reasons, but are typically low, solid-wall frames with transparent tops. Cold frames are typically built outdoors, in or near the garden space, so that the plants may be “hardened-off” (acclimatized to the outdoors) prior to the opening or removing of the cold frame or prior to the final transplanting of the plants to the garden. Also, trellis and wire-cage systems have been designed for supporting tomatoes and other plants during the growing season, to keep the plant(s) from falling over or breaking, and/or to control the direction and position of branches and fruit/vegetables. Such trellis and cage systems may be covered with tarps or wraps, to protect against a cold-snap or cold fall nights.

Still, the inventor believes there is a need for an improved system that may provide both protection and plant-support. There is a need for a system that, in certain embodiments, protects a plant(s) from cold, wind, or excessive sun, for example, during early-planting, hardening-off, inclement weather, and/or extreme heat, and yet may also support the plant as it gains size and matures during the main and later portions of the growing season. There is a need for a system that meets some or all of these goals, while being easy to store, carry, and use, and easy-to-modify for various species and numbers of plants and during the course of the growing season.

### SUMMARY OF THE INVENTION

The invention comprises a plant growing system that is adapted to support a plant, and preferably to also protect the plant from cold, wind, inclement weather, and/or excessive sun. The system may comprise frames for support of the plants and/or for holding panels that protect the plants. By using certain embodiments of the system, a gardener has the flexibility to plant young plants outdoors early in the spring, without worry that cold nights, a “cold snap”, or harsh weather will damage or freeze the young plants. By planting early but also protecting the young plants, the plants get an early start as soon as the soil warms sufficiently, and they grow faster in the protected interior of the system. Certain embodiments may use one or more transparent or translucent panels to shelter young plants from wind and cold air, while allowing light to reach the plants. Certain embodiments may utilize one or more opaque panels, in addition to or instead of transparent/translucent panels, to shade the young plants during a “hardening-off” period, for example.

In certain embodiments, multiple cooperating frames are pivotally connected to form a modular support unit of various sizes and shapes. The frames may comprise feature(s) that serve, when the frames are connected, to stabilize the unit, for example, a latching or locking function that helps prevent the frames from becoming academically disconnected from each other. The frames may comprise feature(s) that allow, and stabilize, stacking of multiple units for accommodating taller plants.

In certain embodiments, one or more of the frames, or all of the frames, are adapted to receive panels that close or substantially close one or more, or all, sides of the unit. Optionally, but preferably, the frames are adapted to receive panel(s) to close the top of the unit. Said panels are preferably have at least one face that is continuous or substantially continuous, so that the panels block cold air-flow, wind and/or generally protect or insulate the space inside the unit. Said panels may be transparent or translucent to allow sun to reach the plant(s), while still protecting the plant from the cold/wind. Alternatively, said panels may be opaque or partially opaque to shade plants as needed, for example, during “hardening-off” or extreme sun and heat. The frame(s) may be specially-adapted to removeably receive and hold the panels, preferably by virtue of the shape and arrangement of the horizontal and vertical members of the frames, rather than by requiring conventional fasteners. For example, in certain embodiments, the frames receive and retain the side panels by their horizontal rung members being offset forward and rearward, so that the side panel is slid between the offset rung members, to be received and retained by at least one rung being in front of, and at least one rung being in back of, the side panel. In certain embodiments, therefore, the frames are adapted to removeably receive and hold the panels without ties, straps, pins, latches, locks, hooks, loops, or other moveable/removable fasteners.

Various means and methods of accomplishing some or all of these functions and goals will be apparent from the following description and drawings, wherein certain, but not all, embodiments are detailed and described. Those of average skill in the art, after viewing the following description and drawings, will understand many modifications from the embodiments specifically detailed and described may be made that are within the scope of the claimed invention.

### BRIEF DESCRIPTION OF THE DRAWINGS

FIG. 1 is a front view of one embodiment of an invented frame.

FIG. 2 is a cross-sectional, top view of the frame of FIG. 1, viewed along the line 2-2 in FIG. 1.

FIG. 3 is a left side view of the frame of FIG. 1, that is, viewing the embodiment of FIG. 1 as if from the left edge of the paper.

FIG. 4 is a front perspective view of the frame of FIG. 1, with one embodiment of a panel inserted into the frame, wherein the panel is shown in dashed lines for ease of viewing.

FIG. 5 is a cross-sectional side view of the frame and panel of FIG. 4, viewed along the line 5-5 in FIG. 4, wherein the panel is shown in cross-hatch lines.

FIG. 5A is a cross-sectional side view of the frame, as in FIG. 5, except that the panel is partially raised above the frame, showing that the panel is slid parallel to the frame for insertion or removal.

FIG. 6 is a partial, perspective view of the bottom end of two frames of FIG. 1 connected together.

FIG. 7 is a partial, perspective view of the connected top portions of the frames of FIG. 6.

FIG. 7A is a detail, top view, as indicated by the dashed circle in FIG. 7, of two rungs and their respective vertical members, wherein the angle of the frames to each other results in the end of the left rung being above, and blocking upward movement of, the end of the right rung.

FIG. 8 is a front view of portions of the frames of FIGS. 6 and 7, being connected by the right frame being closely adjacent to, and lowered relative to, the left frame.

FIG. 9 is a perspective view of four of the frames of FIG. 1, connected together in a square unit, wherein two removeable panels (in dashed lines) are shown inserted in the two frames nearer the viewer. Panels may be likewise inserted into one or both of the rear two frames. The unit may have protective panels on none, one or more, or all, sides of the unit, as desired to protect the plant(s) growing within.

FIG. 10 is a perspective view of the unit in FIG. 9 with an added roof embodiment having a slidable panel. As in FIG. 9, panels are shown inserted into the two front frames, but protective panels may be installed on none, one or more, or all, sides of the unit.

FIG. 10A shows the unit of FIG. 10, with a small tomato plant growing inside the unit. The roof panel is closed and two side panels are shown in dashed lines, but one or two additional side panels may be used to more fully shield the plant from cold or windy weather. Further, panels may be selected to control the amount of sunlight reaching the plant, for example, by selecting opaque or partially opaque panels in addition to, or instead of, transparent or translucent panels.

FIG. 10B shows the unit of FIG. 10, with the slidable roof panel and side panels removed, and a larger plant growing up partially out of the open roof and being supported by the rungs of the frames, for example, later in the growing season.

FIG. 11 shows the unit of FIG. 10, with the two front panels portrayed as opaque panels in solid lines, showing that only certain of the rungs are outside the panel and visible from outside the unit.

FIG. 12 is a cross-section of the unit of FIG. 11 along line 12-12 in FIG. 11, viewing the front two frames and panels of FIG. 11 from the inside of the unit to show the inside rungs.

FIG. 13 is a partial, side view of the top end of the unit of FIG. 10, viewing the roof from a left-front position in FIG. 10, wherein the roof brackets have been pushed down so that the cylindrical connectors protrude up slightly above the brackets.

FIG. 14 is a top perspective view of the roof of FIGS. 10 and 13, illustrating the roof panel being slid in and out of the roof brackets.

FIG. 15 is a detail view of a combination of the top ends of two lower, connected frames (such as in FIG. 7), plus the bottom end of two additional frames stacked on-top of the lower frames.

FIG. 16 is a perspective view of a combination of a lower, four-frame unit, such as in FIG. 9, plus an upper unit of four frames stacked on top of the lower unit, wherein neither unit has panels installed and wherein only the lower portion of the upper unit is shown for the sake of enlargement.

FIG. 16A illustrates the embodiment of FIG. 16 in use around a potted plant, for example.

FIG. 17 shows an alternative arrangement of eight of the frames of FIG. 1, the arrangement forming an elongated rectangular shape (when viewed from the top), with panels (in dashed lines) installed along one side, and without any roof. As in other examples, protective panels may be installed in none, one or more, or all, frames of the unit.

FIG. 18 shows an alternative arrangement of five of the frames of FIG. 1, the arrangement comprising pairs of frames connected with ties to form a zig-zag “fence” support unit without any panels.

FIG. 19A is a top view of an alternative frame with all rungs on one side of the vertical poles, rather than being staggered front and back, and wherein a panel is held between two inwardly-facing channels.

FIG. 19B is a top view of an alternative frame with rungs alternating between the two sides of the frame and with channels fixed to some of the rungs for holding a panel.

FIGS. 20A and B are top views illustrating some, but not the only ways, of holding a panel on a frame with tie(s) and/or clip(s). In FIG. 20A, ties or straps pass through small apertures in the panel and around the vertical poles, ties or straps pass through small apertures in the panel and around one or more rungs, and a clip extends around members of the frame and engages the panel. In FIG. 20B, the panel is placed on one side of the frame, away from the vertical posts, ties/straps extend through small apertures in the panel and around at least one of the rungs, and a clip is provided.

### DETAILED DESCRIPTION

Referring to the Figures, there are shown several, but not the only, embodiments of the invented modular plant growing system, which may comprise plant support and/or protection features. The system comprises at least one frame, the preferred embodiment of which is portrayed in the figures as frame 10. Frame 10 comprises multiple generally vertical members 12, 14 (hereafter “poles”), and multiple generally horizontal rungs 21, 22, 23, 24, and 25 (hereafter “rungs”). Both poles and rungs may be metal rods, for example, ¼inch diameter galvanized steel rods welded. The poles 12, 14 are preferably parallel to each other and spaced apart to be at or near the outermost right and left extremities of the frame 10. The rungs 21-25 are also spaced apart along the length of the frame 10, from at or near the top of the frame 10 to near the bottom of the frame 10. The poles 12, 14 each extend at their top ends (“left arm 13” and “right arm 15”) up above the top rung 21 about 1-3 inches, and more preferably 1-2 inches. The poles 12, 14 each extend at their bottom ends down below the bottom rung 25 about 2-4 inches, so that the bottom “legs” 17, 19 may rest on or stick into the ground.

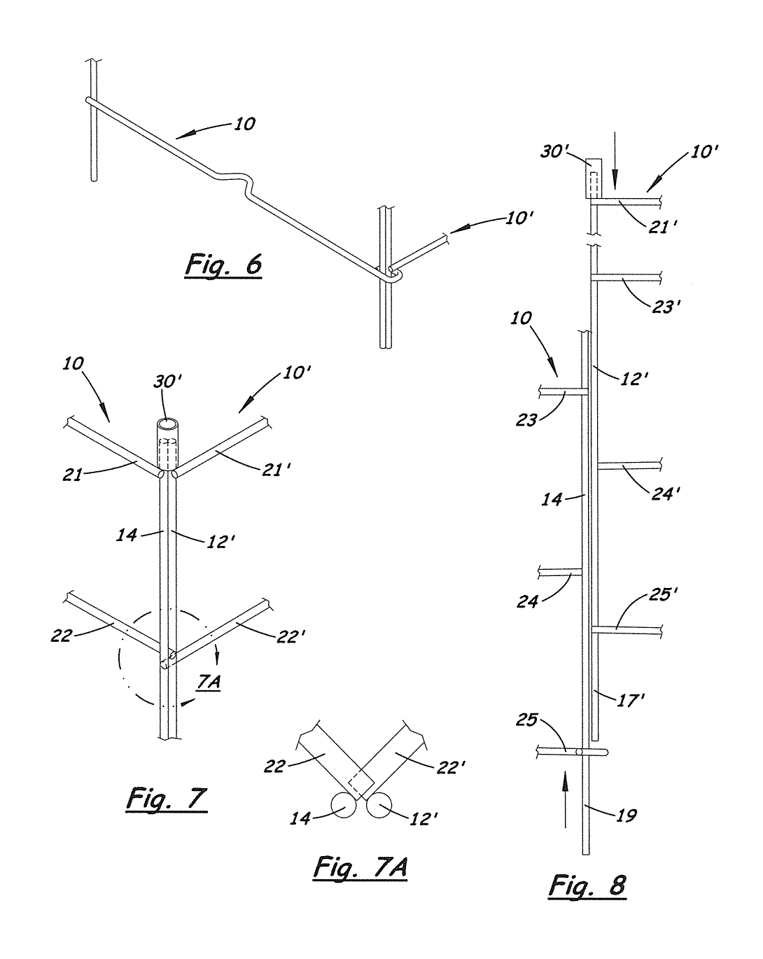

At the right end of bottom rung 25 and the top of pole 12 are right and left connectors, respectively, for connection of the frame 10 to another frame, for example, frame 10′ in FIGS. 6-8. By connecting two or more frames, in a modular manner, various shapes and sizes of units may be formed. The various shapes and sizes may be designed to fit various plants, garden spaces and/or planters, for example. Frames 10, 10′ and other connected frames may all be identical or are preferably at least sufficiently similar that they may be connected end-to-end in a modular fashion in various lengths and/or shapes.

As shown in FIG. 6, the right connector is preferably a hook or loop member such as loop 32. The loop 32 is preferably curved around pole 14 to surround the pole 14 while also being large enough to leave an open loop space 33 in which a leg of another frame is inserted. The loop 32 is preferably fixed to pole 14 by welding, for example. In FIG. 6, one may see that the left leg 17 of frame 10′ is inserted through the loop 32 to be parallel and closely adjacent to (and/or touching) the right leg 19 of frame 10. Thus captured in the loop, the left leg 17 may rotate in the loop 32, to allow the leg 17 to pivot relative to frame 10.

Details of connection of two frames 10, 10′ are shown in FIGS. 7, 7A and 8. Portions of the two frames 10, 10′ are called out with similar numbers but with the portions of frame 10′ marked with a prime.

As shown in FIG. 7, the left connector is a connector 30 that surrounds and is fixed to the left arm 13 of the frame 10′ just above the top rung 21′. Connector 30 is shown as a hollow cylinder in the drawings, but may be other shapes, such as an oval, ring, hook, or other shapes that surround or extend from the left arm 13 to surround or otherwise capture the right arm 15 of an adjacent frame. For example, the connector may be a ½ inch inner diameter galvanized steel cylinder welded to the upending left arm 13 of pole 12′. The connector 30 is fixed to the left arm 13 so that the arm 13 is off-center in the cylindrical interior space of the connector, preferably fixed to the inner wall of the interior space and extending less than half way across the diameter of the interior space. This way, there is room in the interior space for slidably receiving the right arm 15 of frame 10 parallel and closely adjacent to (and/or touching) the left arm 13 of frame 10′. Thus captured in the connector 30, the right arm 15 may rotate in the connector 30, to allow the arm 15 to pivot relative to frame 10′. In alternative embodiments, connector 30 or another encircling/cap member may be detachable from left arm 13, for lowering onto both left arm 13 and right arm 15, once the left arm 13 and the right arm 15 are placed closely adjacent, to connect the arms 13, 15.

From the above description and the figures, one may understand that connection between frames of certain embodiments comprises only rotatable connection near the top and the bottom of the frames that allow the frames to pivot relative to each other. In the preferred embodiments, the rotatable connections of arm 15 to connector 30, and of leg 17 to loop 32, with no other required connections between the frames 10, 10′, are sufficient to pivotally connect frames throughout a growing season until the user purposely disconnects them. In certain embodiments, connections other than those formed by connector 30 and loop 32 may be made, for example, hinges, ties, hooks, flexible connectors, or straps may be used to hold frames together.

As illustrated in FIG. 8, the connector 30 of frame 10′ and the leg 17′ of frame 10′ both slide downward onto/into the cooperating portions of frame 10, specifically, top arm 15 of frame 10 and loop 32 of frame 10. Thus, in FIG. 8, the movement of the frame 10′ downward relative to frame 10 accomplishes the connection, without any significant bending, bowing, or disassembly (and preferably without any bending, bowing, or disassembly) of either frame.

The two frames 10, 10′ in FIG. 8 are preferably connected when they are generally co-planar, for example, about 180 degrees apart or in the range of about 141-180 degrees apart, or more preferably about 150-180 degrees apart. When in such an orientation, during connection and after connection, the rungs of frame 10 do not abut into the rungs of frame 10′. For example, this may be accomplished by rungs 21-24, and the left end of rung 25, not extending out beyond their respective poles 12, 14, or less preferably, only extending out beyond the poles 12, 14 a very limited distance. During connection, the ends of rungs 21-24, and the left end of rung 25, move/slide past each other until frame 10′ is fully lowered relative to frame 10. In this “fully-lowered” position, the bottom rung 25 of frame 10′ rests on the bottom rung 25 of frame 10, that is, on the loop 32 of rung 25 of frame 10. It may be noted that adjacent frames, in certain embodiments, will not pivot very far, if at all, past “co-planar” (past 180 degrees), for example, because rungs and/or connectors interfere with said pivoting past co-planar. For example, one may see that rungs 21, 21′ in FIG. 7 may interfere with the two frames in FIG. 7 pivoting toward the viewer of FIG. 7 past approximately co-planar.

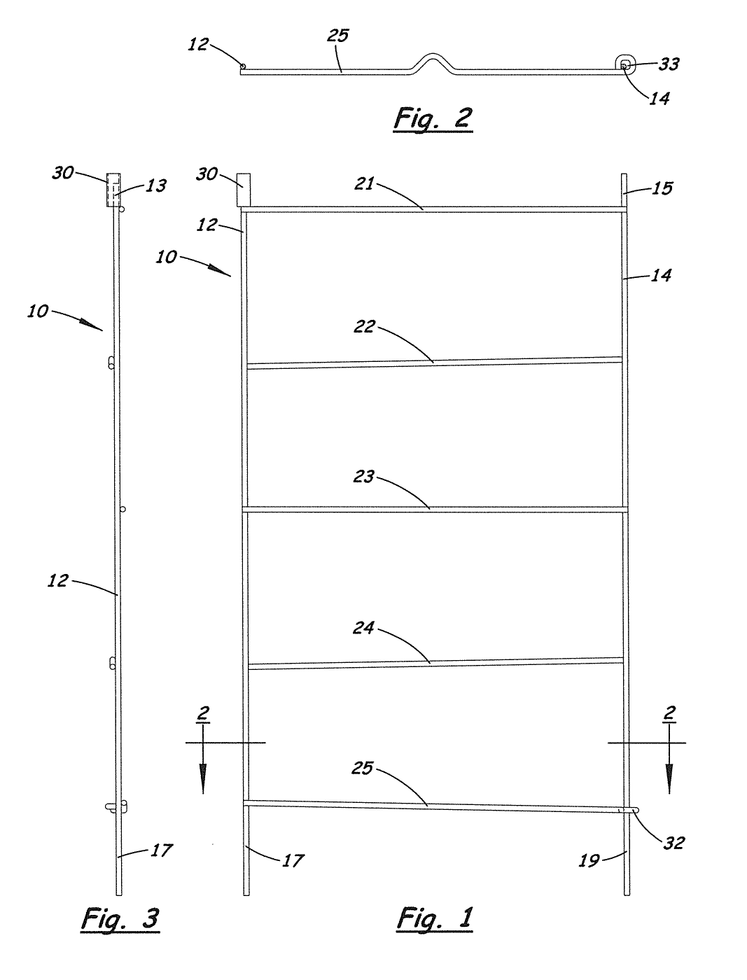

To accommodate the bottom rung's resting on the loop 32 without frame 10′ being pushed up at its left side relative to the right side of frame 10, bottom rung 25 is slanted slightly upward from the right to the left, as may be seen in FIG. 1. In other words, the bottom rung of each frame 10, 10′ is slanted upward from right to left and its right end is connected slightly higher on vertical member 14 than its left end is connected on vertical member 12.

After connection of the frames 10, 10′, it will be common to pivot the frames relative to each other, for example, to make a square unit, a rectangular unit, a polygonal unit such as a hexagon, or a zig-zag unit. When two frames 10, 10′ are pivoted rearward, from their position in FIG. 8, to be at an angle rather than generally co-planar, for example, an angle of about 140 degrees or less (about 90 degrees for a square unit), the inner rungs 22 and 24 of frame 10 will crossover the corresponding inner rungs 22, 24 of frame 10′, acting as a latch/lock to block or at least hinder vertical movement of frame 10′ upward relative to frame 10. See FIG. 7A. A vertical movement of frame 10′ upward relative to frame 10 is required in order to disconnect the frames 10, 10′ (the opposite action compared to FIG. 8), this latch/lock feature helps keep a multiple-frame unit (when its frames are at angles to each other) connected and stable. This way, frames connected and “latched” or “locked” in this way will tend to resist disconnection, for example, by wind, gardeners working with the supported/closed plants, or animals pushing on the unit. When the gardener wishes to separate the frames, he/she may pivot the unit to move two given frames to be close to, or generally, co-planar, for example at least 141 degrees apart, so that the connector 30 and the leg 17 may be lifted up away from the other frame's arm 15 and loop 32, respectively. For example, in the case of a square unit, the “square” may be collapsed to a diamond shape comprising two frame-connection angles each of about 150 degrees between frames, and two frame-connection angles each of about 30 degrees, so that the frames forming the larger angles (about 150 degrees) of the diamond may be disconnected from each other.

Note that the above-described latch feature is enabled by virtue of the right ends of the rungs 22, 24 being higher on the frame that the left ends of the rungs 22, 24, that is, the right ends of rungs 22, 24 are connected slightly higher on vertical member 14 than the left ends of rungs 22, 24 are connected to vertical member 12. Because the rungs 22, 24 are preferably straight rods, this translates to the rungs being slanted downward from the right to the left.

It will be understood that each frame 10, 10′ may be effective in supporting a plant, for example, a tomato plant, a vine plant such as peas or beans, or other plants. The rungs 21-25 provide horizontal support, while the spaces between the rungs are comfortably wide enough for the gardener to reach through for manipulation, trimming, or picking of plant branches, leaves and/or fruit/vegetables. Preferably, each frame is about 34-36 tall including the connector 30 and the legs 17, 19, and the spaces between the rungs are about 8 inches. A gardener may use additional means, such as conventional ties or wraps, to direct or control the branches of the plant being grown, if desired.

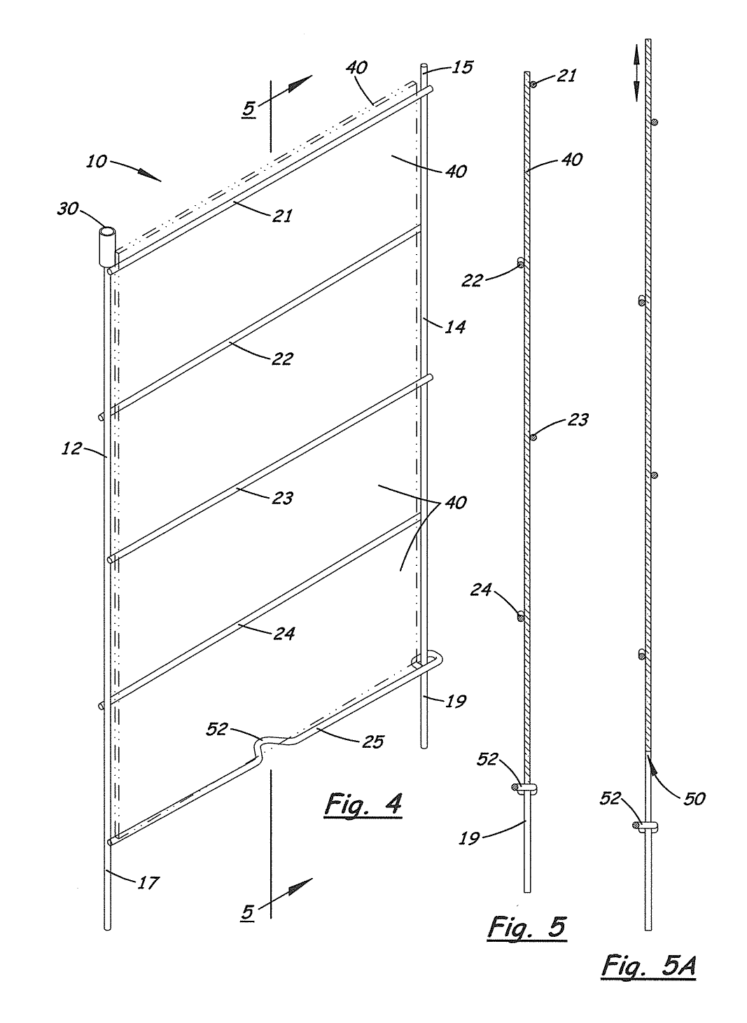

FIGS. 4, 5, and 5A shown one but not the only embodiment of the frame 10 being adapted to provide protection/shielding. A single frame 10 is shown in FIG. 4, with a side panel 40 (dashed lines) inserted into the frame, and it will be understood that frame 10′ and other identical or similar frames may also receive the same or similar side panels. In most embodiments, the side panels 40 will be solid and continuous, at least on the front or rear surface of the panel and optionally all through the panel. This way, such solid and continuous panels may block cold and wind from the interior space 35 (the space inside the boundary formed by the frames), for shielding and protecting the plant(s) contained therein. Gaps between the panels and the frame and/or between the frames may allow air flow into the interior space 35, but these gaps are preferably small and allowed air flow will be small. In certain embodiments, side panels 40 will be translucent or transparent, to allow light into the unit interior space for plant growth as soon as the soil temperature allows, even if the ambient air or nights are cool. Alternatively, one or more portions of the panel, or the entire panel, may be opaque, for providing shade or partial shade for the plant(s) within the unit interior space.

The preferred panels 40 are firm plastic or generally rigid plastic, for example, ¼ inch thick plastic panels that are self-supporting but that may flex slightly to make insertion into the frames convenient. For example, ¼ inch thick clear, or other highly-light-transmitting, polycarbonate sheets may be used for as transparent/translucent panels. Or, ¼inch thick, opaque panels may be used as panels for hardening-off or other shading applications. Twin-wall corrugated plastic or polycarbonate sheets are especially-preferred, as they are strong, durable, generally rigid, and yet light-weight. The preferred roof panel 140, described later in this document, may be selected from the same materials as the side panels 40, for example.

FIGS. 5 and 5A illustrate how the panel is captured between the rungs 21-24, which alternate being outside rungs and inside rungs by being connected to the front and back of the vertical members, respectively. Thus, it will be understood that the alternating rungs form a generally vertical space 50 between the rungs that can receive a thin sheet such as panel 40. As the poles 12, 14 are about ¼ inch in diameter, and the rungs defining the front and the rear of the space 50 are fixed to the front and rear of the poles, the space is about ¼ inch wide all along its length. The panel is inserted into, and pulled from, that space 50 from the top of the frame, as shown in FIG. 5A. The fully-inserted panel 40 rests on a stop, such as the rung protrusion 52 of the bottom rung 25, which extends out across/underneath the space 50 to prevent the panel 40 from falling/going below the bottom rung 25. It is preferred that the panel be sized to fill most or all of the distance between the poles 12, 14 and most or all of the space extending from the top surface of the bottom rung 25 to about the top rung 21, for efficiently blocking most of the wind and cold from entering the unit interior space 35. The panel top edge may extend up slightly higher than the bottom rung 25, or the panel may be flexible enough that a user can flex the top end of the panel to grasp the top edge, for pulling the panel up out of the frame.

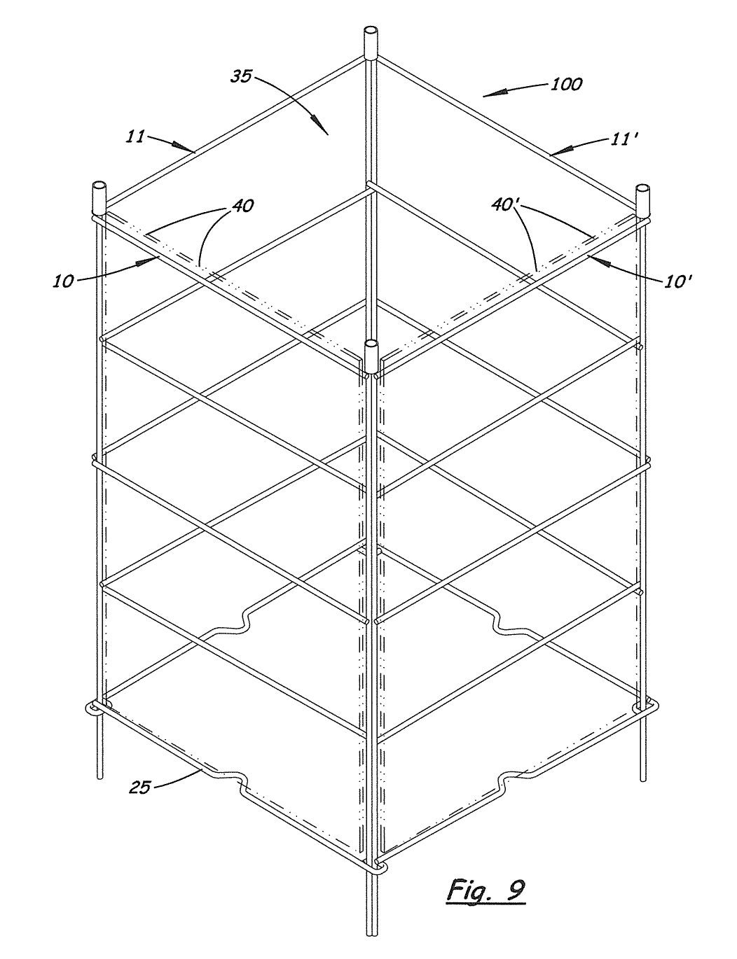

FIG. 9 shows an example of four frames being connected in a square unit 100, comprising panels 40 (in dashed lines) in the two frames 10, 10′ at the front of the figure. The two other frames 11, 11′ in this figure are shown without panels, but panels may be inserted into frames 11, 11′ if desired for further shielding/protection. The unit 100 as configured in FIG. 9 could be useful in protecting plants inside the interior space 35 from wind approaching the front of the unit (panels 40, 40′), and, if panels are inserted into all four frames, from wind or cold air around the entire unit 100.

The legs of the unit 100, below the bottom rungs (25), may rest on a surface such as garden dirt, a patio, rocks or gravel, or optionally may be pushed into said dirt or gravel. It is preferred that the frames not be “pounded” into the ground, and stakes or pins (not shown) may be connected to the frames for securing the unit 100 to the ground. Preferably, said stakes or pins are placed through a ring or loop (not shown) provided at the intersection of the vertical poles and the bottom rung, so that the ring/loop and stakes or pins do not interfere with insertion of the panel all the way down to the bottom rung of the frame.

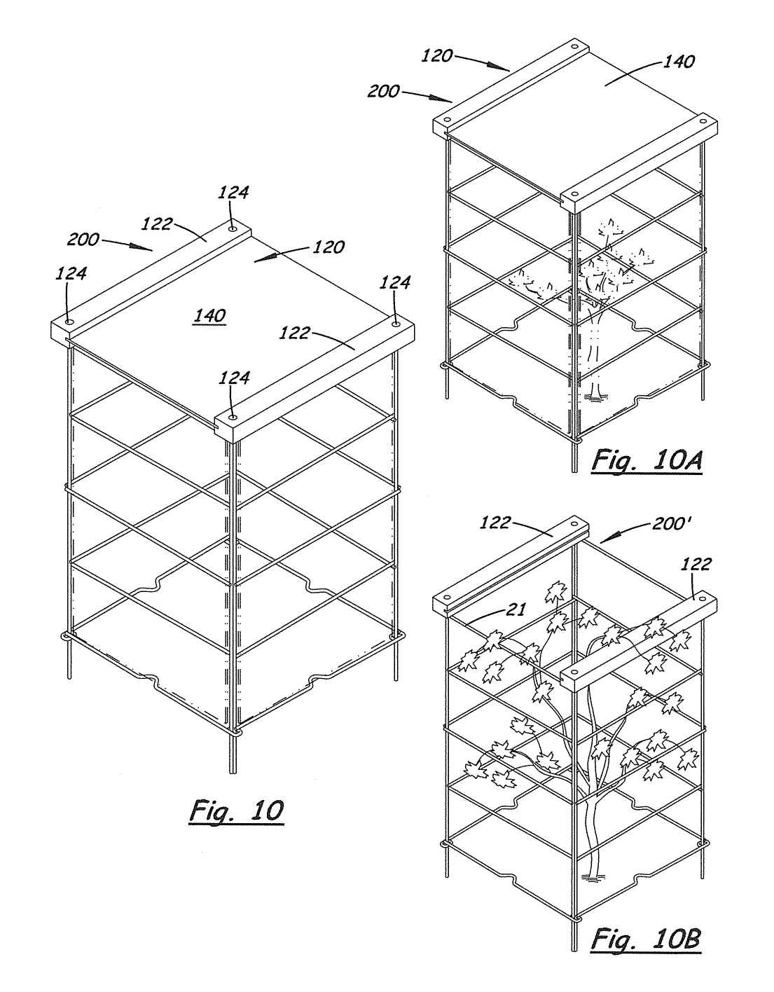

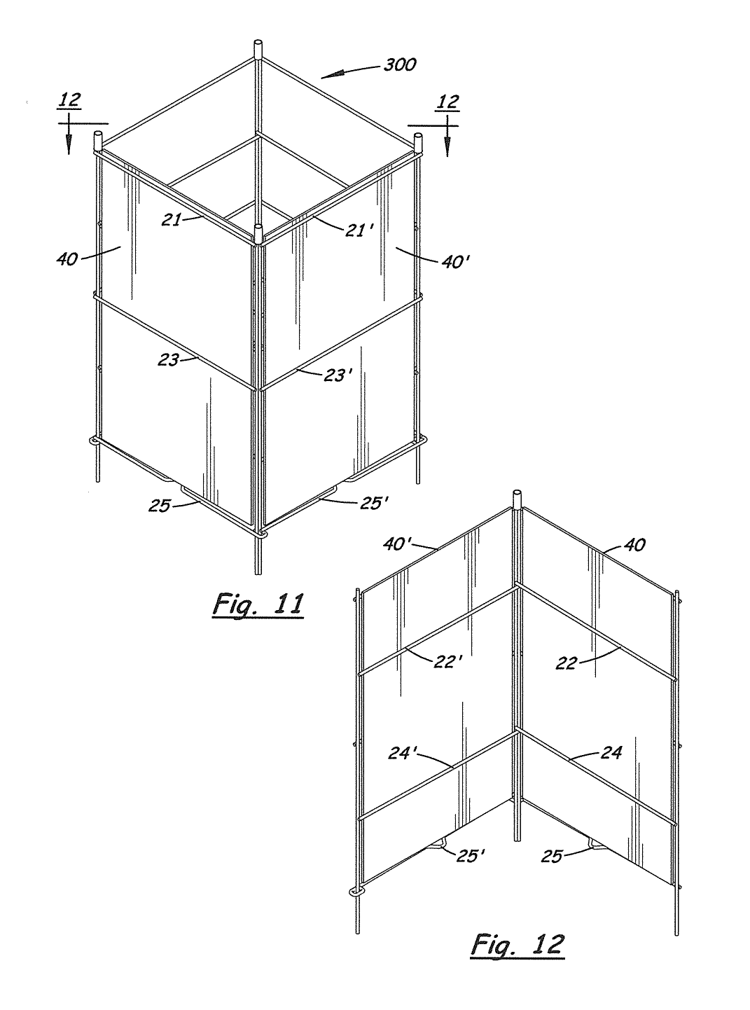

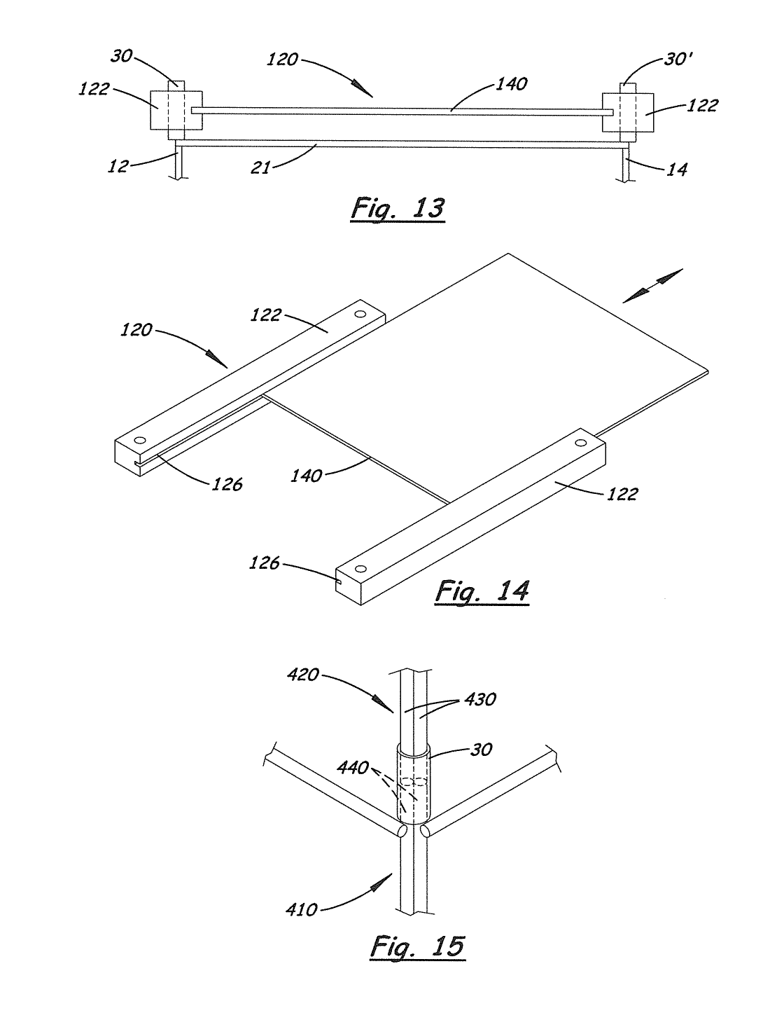

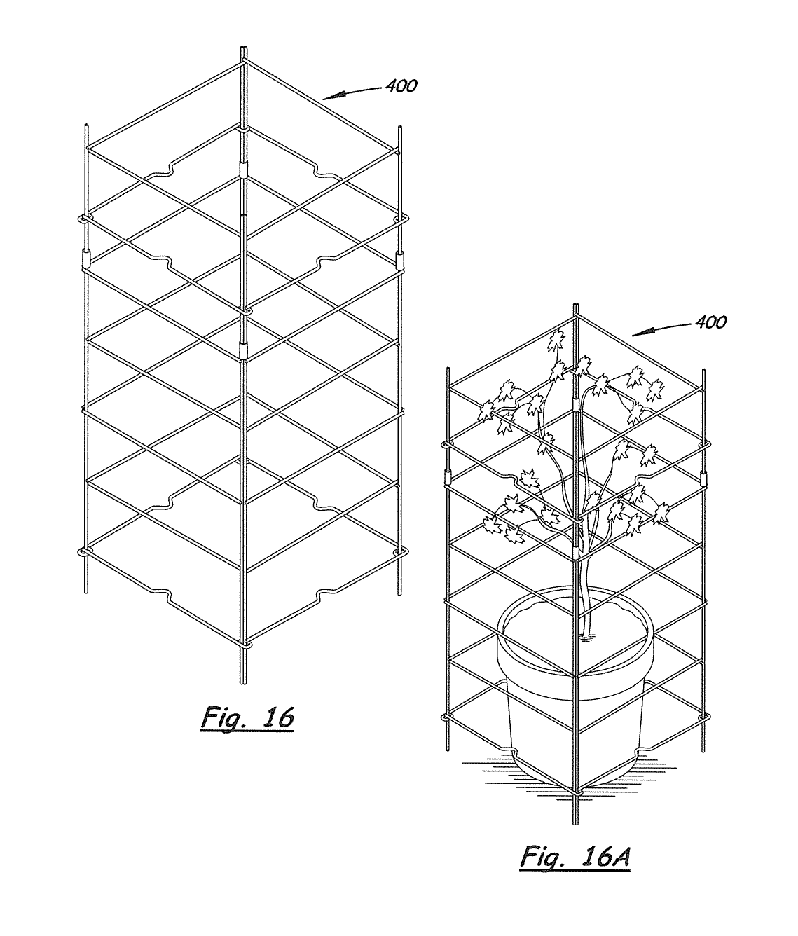

FIG. 10 shows one embodiment of a roof 120 that may be installed on top of a unit, for example, on top of unit 100 of FIG. 9, forming unit 200. The roof 120 comprises two brackets 122 that are installed over the four connectors 30 of the frames, by means of two holes 124 in each bracket 122 removably sliding over two connectors 30. A horizontal roof panel 140 slides into inner channels 126 of two brackets 122 that face each other. Example details of the roof 120, and how the panel 140 may be slid in and out of the brackets 122, are shown in FIGS. 13 and 14. Unit 200 is shown in FIG. 10A with the roof closed and with two side panels installed and a small plant being protected inside the unit 200. Panels 40 may be installed in any number of the frames, but during the first weeks of spring, panels will typically be installed in all four frames to protect the plant(s). This way, the plants are protected and start to grow quickly inside the enclosed or substantially-enclosed unit 200 once the soil warms to a temperature above about 50 degree F.

The unit 200 may also aid in the known process of “hardening-off” a plant when it has just been transplanted outdoors from a greenhouse. For example, during the first days after transplanting a tomato plant out to the garden, panels may be installed all around the plant, with some or all being opaque or partially-opaque panels to shield the plant from the bright sun, in the “hardening-off” process. After this process, the opaque/partially-opaque panels may be replaced with transparent/translucent panels for accelerating growth by allowing light to reach the plant while continuing protection from cold and wind.

Once the soil and the weather warms, the roof may be opened by removing the roof panel 140 from the brackets, and one, multiple, or all of the side panels 40 may be removed. FIG. 10B illustrates the unit of FIGS. 10 and 10A modified to be unit 200′, wherein the roof panel 140 and all the side panels 40 are removed but the roof brackets 122 are still in place. The plant in FIG. 10B has grown up out of the top of the unit 200′, and multiple branches of the plant are extending between, and being supported by, the rungs of the frames. Alternatively, FIG. 10B may represent that a unit may conveniently be installed around a larger plant, because frames may be disconnected from each other to open-up the unit. Thus, a gardener may install a unit around a larger plant, lay branches over the appropriate rungs or the brackets for support, and close the unit by reconnection of the frames.

FIG. 11 shows a perspective view of a unit 300 of four frames, without a roof and with opaque panels in the front two frames. It may be understood that the rear two panels may be open, that is, not holding panels, so that the rear two panels may support the plant, for example. Such an embodiment may be used to shield newly-transplanted plants from too much sun, for example, for hardening-off. Such an embodiment illustrates that the panels are held behind several of the rungs (21 and 23) but in front of the other rungs (22 and 24). FIG. 12 shows a rear view of the front two frames and their panels, of unit 300 of FIG. 11, so that one may see the rungs 22, 24 visible at the back of the panels.

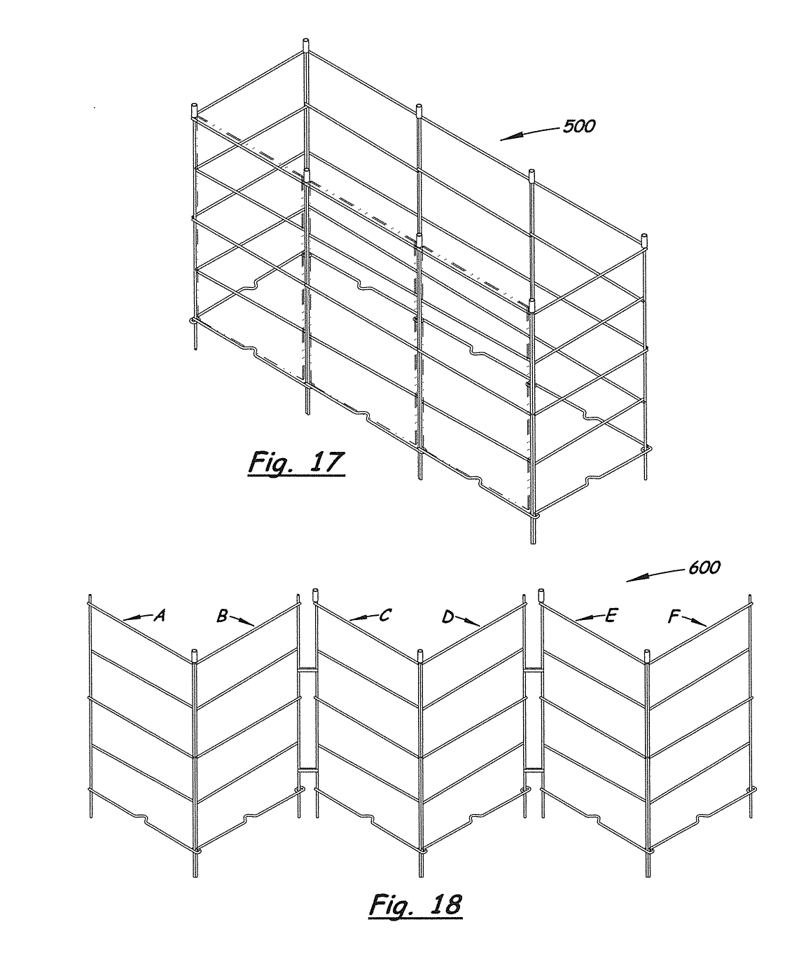

FIGS. 15 and 16 and 16A illustrate that certain embodiments of frames may be stacked on top of each other, for example, to form a two-frame-high unit 400. FIGS. 16 and 16A show only about the lower half of an upper set 420 of four frames that is stacked on the lower set 410 of frames (in order to allow the figures to be enlarged), but it will be understood that the upper set 420 of frames may be the same as the lower set 410 of frames. For example, the upper set 420 may be stacked and connected to the lower set 410, by inserting the legs 430 of the upper set 420 into the connectors 30 of the lower set 410. As shown to best advantage in FIG. 15, the legs 430 of upper set 420 extend into the open tops of the connectors 30, for example, to rest on the top surfaces of the upwardly-extending arms 440 of the lower unit 410. Thus, it may be desirable that the connectors 30 are axially longer than is necessary simply to house and pivotally connect the lower unit's arms 440 together, because both the arms 440 and the legs 430 preferably extend to about the middle of the connectors 30.

Stacking of frames may be advantageous, especially during the later weeks of the growing season, when tall plants may need to be supported. Or, as shown in FIG. 16A, a stacked unit 400 may be beneficial if the plant(s) inside the interior space of the unit 400 is/are in a planter/pot and, hence, is/are raised above the surrounding garden or patio. This way, the stacked unit 400 may rest on the ground/patio around the planter, rather than on/in the dirt inside the planter.

FIGS. 17 and 18 illustrate two, but not the only, alternative configurations of the modular system, wherein multiple frames are connected. In FIG. 17, a long rectangular unit 500 is formed, for example, for a row of tomato plants; panels are shown in the front three panels, but no panels, one or more panels, or one panel for each frame, may be used. For example, more panels or differently-placed panels, could be used for additional wind, cold, and/or sun protection. Or, no panels could be used, for example in the peak of the growing season. In FIG. 18, a zig-zag “support fence” unit 600 of frames is provided, for example, to allow a row of vine plants to grow up the unit 600. Because certain of the frames will not, when connected to each other, pivot past about 180 degrees from each other, FIG. 18 shows pairs of frames connected, with adjacent pairs tied together. In other words, pairs of frames A and B, frames C and D, and frames E and F, are pivoted rearward in FIG. 18 to about 90-100 degrees from each other. However, frames B and C and frames D and E are disconnected, because their positions in FIG. 18 would require that, if connected, they could pivot forward relative to each other (toward the viewer, past 180 degrees, in FIG. 18). An upper stack of frames could be added to either unit 500, 600, especially if the lower frames were staked into the ground. It will be understood that frame units of various other shapes may be formed from the modular frames. It will be understood that many of the preferred embodiments comprise planar or generally planar frames, preferably with add-on panels that are also planar or generally planar, and that these embodiments are generally, substantially, or entirely vertical rather than conical, for example, not of the “conical tomato cage” type commonly available on the market. It will also be understood that the frames are disconnectable, and stackable with frames and panels parallel to one another, for easy transport and storage in a small space. A bag or cover may be supplied, preferably with a handle for carrying the disconnected frames and panels to a winter storage location.

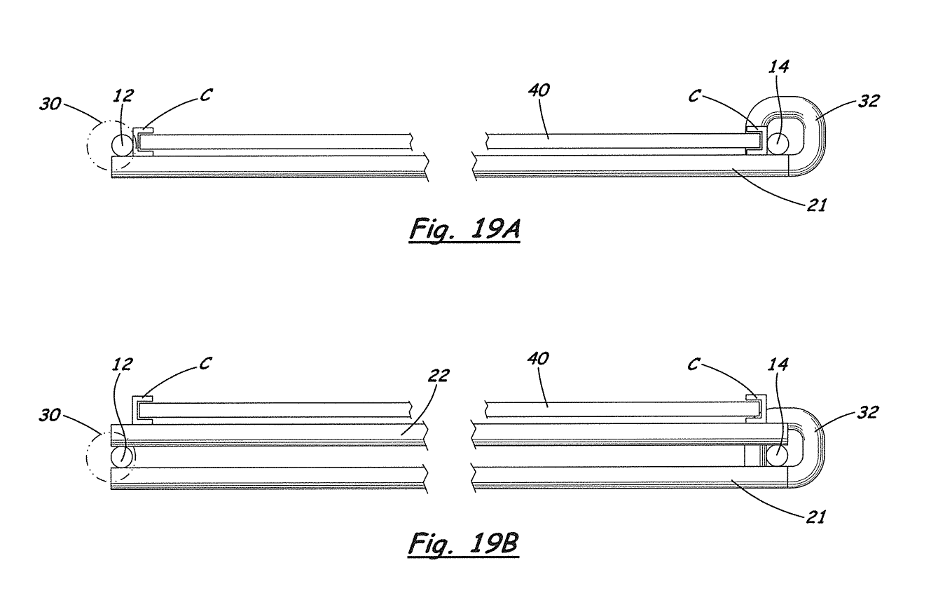

It may be noted that, while the preferred method and means of installing and retaining the protective panels has been described above, other methods and means may be used in certain embodiments, for example, channels, ties or straps, clips or other fasteners. For example, in certain embodiments, channels may be provided into which the panel is slid for holding the panel on/near to the frame to provide the above-described protective/shielding functions. For example, in FIG. 19A, rather than being retained between alternating front and rear rungs, a panel 40 is received in and between two inwardly-facing channels C that are between the vertical poles 12, 14. In FIG. 19A, the channels C may be fixed to the vertical poles and/or the rungs, for example. Rung 21 and the loop 32 of rung 25 are shown in the top view of FIG. 19A. Also, the connector 30 is shown in dashed lines in FIG. 19A. All of the rungs in FIG. 19A may be on one side of the vertical poles 12, 14, rather than being staggered front and back, for example. FIG. 19B shows an embodiment with rungs alternating between the two sides of the frame, as described above in this document, with channels C receiving the panel 40. The channels C may be fixed to some of the rungs, for example including rung 22 and the other rungs on that same side of the frame. Panels slidably received in channels may be held from falling down from the channels by various stops, pins, or other fasteners.

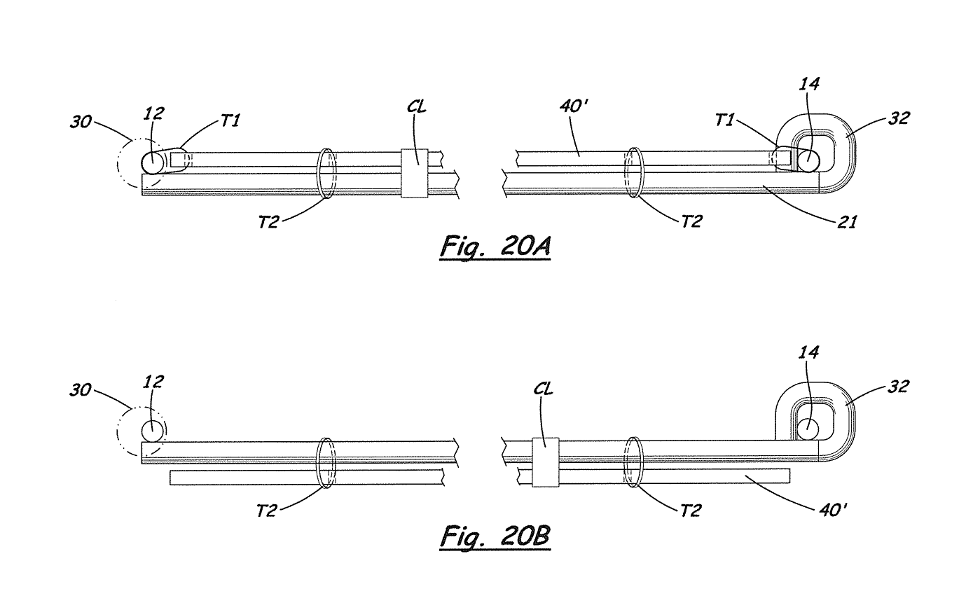

FIGS. 20A and B illustrate some but not the only ways of holding a panel on the frame with tie(s) and/or clip(s). For example, in FIG. 20A, ties or straps T1 pass through small apertures in the panel 40 and around the vertical poles 12, 14. Ties or straps T2 pass through small apertures in the panel 40 and around one or more rungs, such as around rung 21. Clip CL is shown as one example of many clips that could extend around members of the frame (rungs or poles, for example) and engage the panel to hold the panel instead of, or in addition to, the channels or ties/straps holding the panel. FIGS. 20A and B suggest that all the rungs are on one side of the frame (below the poles 12, 13 on the page in these views), rather than being staggered, but it will be understood that ties or clips could be used in embodiments wherein the rungs are staggered. FIG. 20B, which also illustrates an embodiment wherein ties/straps T2 extend through small apertures in the panel 40 and around at least one of the rungs, places the panel 40 on one side of the frame, away from the vertical posts 12, 14. It is easy to see that, with the panel placed as it is in FIG. 20B, the panel would not interfere with rungs being on the other side of the vertical posts as well (above the poles 12, 14 on the page in this view).

Therefore, one may describe certain embodiments of the invention as a plant growing system for protecting at least one plant, the system comprising, consisting essentially of, or consisting of: multiple frames, wherein each frame comprises two generally vertical poles at or near right and left extremities of the frame, and each pole has a front surface and a rear surface, and each frame further comprises multiple generally horizontal rungs fixed to the poles at or near the outer ends of the rungs, wherein said rungs comprise at least one front rung fixed to the front surface of the poles and said rungs comprise at least one rear rung fixed to the rear surface of the poles, so there is a vertical space between the at least one front rung and the at least one rear rung and between the two poles; wherein each frame is connected to at least one other of the frames at or near the right or left extremity of the frame; and wherein at least one of the frames further comprises a panel slidably received in said space for blocking wind, cold air, or sun from passing through the frame between the rungs, wherein the panel is insertable into the space, and removable from the space, by sliding the panel parallel to the poles in between said at least one front rung and said at least one rear rung. The connected frames may form an upending sidewall that defines an interior space with an open top and an open bottom, the sidewall having a transverse cross-section selected from the group consisting of square, a rectangular, a triangle, and a polygon. Each frame may, for example, form one side of the polygon. Alternatively, the connected frames may take the form of an elongated upending fence or trellis, wherein the two end frames are only connected to one frame each (rather than each and every frame being attached to two other frames, as would be the case in a square, rectangle or other polygon). In certain embodiments, a panel such as described above in this paragraph may be received in the vertical space of each of the frames of the sidewall to block wind and cold air from entering the interior space through the frames, or, in the case of the fence/trellis, from passing through the frames to the back side of the fence/trellis. In certain embodiments, a roof may be provided above the sidewall to give the option of closing the top of the interior space. The roof may comprise a slidable roof panel for closing or opening said open top of the interior space. The side panels may be translucent or transparent to allow light into the interior space, or to allow light behind the fence/trellis. Or, at least some of the side panels may be opaque for shading the interior space or shading the space behind the fence/trellis. The roof panel may be translucent, transparent or opaque for similar goals of light transmission or shading.

It is preferred that the frames be pivotally connected so that they may be modules of units of various shapes. The frames are pivotally connected by means that allow them to be disconnected when desired. For example, a hollow connector, or other surrounding/hooking/capturing connector, at a top end of each frame may be rotatably received over an upending top arm of an adjacent frame and a lower leg of each frame may be rotatably received inside a hollow/surrounding/hooking/capturing connector at a lower end of the adjacent frame. Said connector at said top end of each frame may be a hollow cylindrical connector and the hollow connector at said lower end of the adjacent frame may an open loop at an end of a bottom one of said rungs, but other shapes may be used that surround, hook or otherwise capture (preferably rotatably) the adjacent frames cooperating structure. The upper connector (such as connector 30) may be adapted, for example have room at its top even when connected to an adjacent frame, to receive depending legs of a stacked set of frames for a two-high modular unit. When the frames are at angles that place them close to each other, for example, at angles of about 140 degrees or less, ends of the inner rungs may interfere with disconnection of the frames, by the ends preventing relative vertical movement of the frames in directions that would disconnect the hollow connectors from their cooperating/received members. For example, an end of said at least one inner rung of each frame overhangs an end of the at least one inner rung of an adjacent frame to prevent the frames from being pulled vertically apart to disconnect the frames.

In other embodiments, the invention may be described as a plant protection system comprising, consisting essentially of, or consisting of: an upstanding frame comprising two generally vertical poles at or near right and left extremities of the frame, and multiple generally horizontal rungs fixed to the poles at or near the outer ends of the rungs, wherein said rungs comprise at least one front rung fixed to a front surface of the poles and at least one rear rung fixed to a rear surface of the poles, so there is a vertical space between the at least one front rung and the at least one rear rung and between the two poles; and a panel slidably received in the space the panel parallel to the poles in between said at least one front rung and said at least one rear rung, so that the panel blocks wind, cold air, or sun from passing through the frame between the rungs to protect a plant growing behind the frame. Certain of these embodiments may be described as a trellis or fence that is elongated and has end frames connected each only to one other frame (rather than being connected in a polygon). Multiple of the frames may comprise one of said panels and at least one of the panels may be transparent or translucent. Or, multiple of the frames may comprise one of said panels and at least one of the panels may be opaque. Said multiple frames may be pivotally connected by a top hollow member being provided at or near an upper end of the left vertical side edge of each frame and a bottom hollow member being provided at or near the lower end of the right vertical side edge of each frame, wherein said each top hollow member and said bottom hollow member rotatably receive elongated members of adjacent frames. Said elongated members of adjacent frames may be selected from the group consisting of, for example, an upending arm at a top end of the each frame and a depending leg at a bottom end of each frame. The top hollow member of each frame may be a hollow cylinder adapted to receive depending legs of an upper set of connected frames for stacking frames on top of each other, so that there may be a lower set of frames and an upper set of frame. The bottom hollow member of each frame may be a loop protruding from an end of a bottom-most rung of each frame.

In certain embodiments, whether the frames are connected in a polygon sidewall shape or a fence/trellis form, and whether a single set of frames is used, or stacked sets of frames are used, all the frames may be identical in structure, or so very close in structure. This way, multiple frames may be provided in a modular kit that can be used to make many different frame units, wherein the individual frames are interchangeable with any other frame in the unit.

In certain embodiments, the invention may be described as a modular plant growing system for protecting and supporting at least one plant, the system comprising, consisting essentially of, or consisting of: multiple vertical frames each comprising generally vertical poles at or near right and left extremities of the frame, and multiple generally horizontal rungs connected to the poles at or near outer ends of the rungs, said frames removably and pivotally connected together at or near said right and left extremities to form a vertical upending sidewall defining an interior space for receiving a plant; and panels removably attached to a plurality of the frames to block wind, cold air, or sun from passing through said plurality of frames, the panels being removable from the plurality of frames to allow wind, air and sun to pass into the interior space and to allow the plant to grow through and be supported by at least one of the frames. Each panel may be removably attached, for example, by one or more connections selected from the group of: the rungs of the frame being offset to front and back of the frame to form a vertical space between the offset rungs slidably receiving said panel; channels slidably receiving edges of the panels; ties; straps; clips; and other fasteners. The modularity results from adaptations of certain embodiments wherein all the frames are interchangeable, all the side panels are interchangeable, the frames are pivotally connected and pivot at least 90 degrees relative to each other (and more preferably at least 130 degrees, and more preferably at least 160 degrees), and, optionally, the frames may be stackable. In certain embodiments, the connected frames pivot almost 180 degrees relative to each other, for example, about 170 degrees. The number of frames and angles between the frames may be selected so that the sidewall is of many different shapes, for example, a transverse cross-section selected from the group of: square, a rectangular, a triangle, and a polygon. Or, a support fence, with frames in a line or zig-zag, may be formed. Another adaptation in certain embodiments may be that, when the frames are at less than a certain angle (for example, less than about 150 degrees, less than about 140 degrees, less than about 130 degrees, or less than about 120 degrees) to each other, the frames are not disconnectable, and when the frames are at that certain angle or greater (for example, at 150 degrees or greater, at 140 degrees or greater, at 130 degrees or greater, or at 120 degrees or greater) to each other, the frames are disconnectable. Said certain angle is preferably 140 degrees in many embodiments, as this allows the “locking/latching” of the frames from disconnection when the frames are in most polygonal shapes, for example, up to and including a nonagon (triangle, square, pentagon, hexagon, heptagon, octagon, and nonagon) because the interior angles of all these polygons are each 140 degrees or less.

Although this invention has been described above with reference to particular means, materials and embodiments, it is to be understood that the invention is not limited to these disclosed particulars, but extends instead to all equivalents within the scope of the following claim.

1. A plant growing system for protecting at least one plant, the system comprising:
multiple frames connected together, wherein each frame comprises generally vertical poles at or near right and left extremities of the frame, and each pole has a front and a rear, and each frame further comprises multiple generally horizontal rungs fixed to the poles at or near outer ends of the rungs, wherein said rungs comprise at least one front rung fixed to the front of the poles and said rungs comprise at least one rear rung fixed to the rear of the poles, so there is a vertical space between the at least one front rung and the at least one rear rung and between the two poles;
wherein at least one of the frames further comprises a panel slidably received in said space for blocking wind, cold air, or sun from passing through the frame, wherein the panel is insertable into the space, and removable from the space, by sliding the panel parallel to the poles in between said at least one front rung and said at least one rear rung.

2. The plant growing system as in claim 1, wherein the connected frames form a sidewall that defines an interior space with an open top and an open bottom, the sidewall having a transverse cross-section selected from the group consisting of: square, a rectangular, a triangle, and a polygon.

3. The plant growing system as in claim 2, wherein panels are received in the vertical space of all of the frames of the sidewall to block wind and cold air from entering the interior space through the frames.

4. The plant growing system as in claim 3, further comprising a roof provided above the sidewall and comprising a slidably roof panel for closing said open top of the interior space.

5. The plant growing system as in claim 1, wherein said panel is translucent or transparent.

6. The plant growing system as in claim 1, wherein said panel is opaque.

7. The plant growing system as in claim 4, wherein the roof panel is translucent or transparent to allow light into the interior space through the roof.

8. The plant growing system as in claim 3, wherein the roof panel is opaque for shading the interior space from above.

9. The plant growing system as in claim 1, wherein the frames are pivotally connected by a hollow connector at a top end of each frame being rotatably received over an upending top arm of an adjacent frame and a lower leg of each frame being rotatably received inside a hollow connector at a lower end of the adjacent frame.

10. The plant growing system as in claim 9, wherein said hollow connector at said top end of each frame and said hollow connector at said lower end of the adjacent frame are each selected from a group consisting of: a cylindrical connector, a loop, a hollow oval member, and a hook.

11. The plant growing system as in claim 1, wherein, when the frames are at angles to each other of less than about 140 degrees, an end of said at least one inner rung of each frame overhangs an end of the at least one inner rung of an adjacent frame to prevent the frames from being pulled vertically apart to disconnect the frames.

12. The plant growing system as in claim 9, wherein, when the frames are at angles to each other of less than about 140 degrees, an end of the at least one inner rung of each frame overhangs an end of the at least one inner rung of the adjacent frame to prevent the frames from being pulled vertically apart so that the hollow connector is not liftable from the upending top arm and the lower leg is not liftable from the hollow connector at the lower end of the adjacent frame.

13. A plant protection system comprising an upstanding frame comprising two generally vertical poles at or near right and left extremities of the frame, and multiple generally horizontal rungs fixed to the poles at or near the outer ends of the rungs, wherein said rungs comprise at least one front rung fixed to a front surface of the poles and at least one rear rung fixed to a rear surface of the poles, so there is a vertical space between the at least one front rung and the at least one rear rung and between the two poles; and
a panel slidably received in the space of the panel parallel to the poles in between said at least one front rung and said at least one rear rung, so that the panel blocks wind, cold air, or sun from passing through the frame between the rungs to protect a plant growing behind the frame.

14. The system as in claim 13, comprising multiple of said frames pivotally connected together at their vertical side edges, so that the frames form an upending sidewall.

15. The system as in claim 14, wherein multiple of the frames comprise one of said panels and at least one of the panels is transparent or translucent.

16. The system as in claim 14, wherein multiple of the frames comprise one of said panels and at least one of the panels is opaque.

17. The system as in claim 14, wherein said multiple frames are pivotally connected by a top hollow member being provided at or near an upper end of the left vertical side edge of each frame and a bottom hollow member being provided at or near the lower end of the right vertical side edge of each frame, and said each top hollow member and said bottom hollow member rotatably receive elongated members of adjacent frames.

18. The system as in claim 17, wherein said elongated members of adjacent frames are selected from the group consisting of an upending arm at a top end of the each frame and a depending leg at a bottom end of each frame.

19. The system as in claim 17, wherein the top hollow member of each frame is a hollow cylinder adapted to receive depending legs of an upper set of connected frames for stacking frames on top of each other.

20. The system as in claim 17, wherein the bottom hollow member of each frame is a loop protruding from an end of a bottom-most rung of each frame.

21. A modular plant growing system for protecting and supporting at least one plant, the system comprising:
multiple vertical frames each comprising generally vertical poles at or near right and left extremities of the frame, and multiple generally horizontal rungs connected to the poles at or near outer ends of the rungs, said frames removably and pivotally connected together at or near said right and left extremities to form a vertical upending sidewall; and
panels removably attached to a plurality of the frames to block wind, cold air, or sun from passing through said plurality of frames, the panels being removable from the plurality of frames to allow wind, air and sun to pass through the frames and to allow the plant to grow through and be supported by at least one of the frames.

22. The system as in claim 21, wherein each panel is removably attached by one or more connections selected from the group consisting of: the rungs of the frame being offset to front and back of the frame to form a vertical space between the offset rungs slidably receiving said panel; channels slidably receiving edges of the panels; ties; straps; clips; and fasteners.

23. The system as in claim 21, wherein the number of frames and angles between the frames are selected so that the sidewall has a transverse cross-section selected from the group consisting of: square, a rectangular, a triangle, and a polygon.

24. The system as in claim 21, wherein, when the frames are adapted so that, when the frames are at an angle of about 140 degrees or less to each other, the frames are not disconnectable, and when the frames are at an angle of more than about 140 degrees to each other, the frames are disconnectable.
